(19) United States
(12) Patent Application Publication
(10) Pub. No.: US 2013/0270259 A1
(43) Pub. Date: Oct. 17, 2013

(54) DEVICE AND METHOD FOR INDUCTIVELY HEATING METAL COMPONENTS DURING WELDING, USING A COOLED FLEXIBLE INDUCTION ELEMENT

(71) Applicant: Andreas Nebelung, Essen (DE)

(72) Inventor: Andreas Nebelung, Essen (DE)

(21) Appl. No.: 13/988,278

(22) PCT Filed: Nov. 17, 2011
(86) PCT No.: PCT/DE2011/075278

§ 371 Date: May 17, 2013

(30) Foreign Application Priority Data
Nov. 19, 2010 (DE) 102010060690.1

(51) Int. Cl. B23K 13/01; H05B 6/42

(52) U.S. Cl. CPC B23K 13/01; H05B 6/42
USPC 219/617; 219/632

(57) ABSTRACT

Proposed is a device for the inductive heating of metallic components in particular during welding, comprising at least one flexible induction element and at least one flexible coolant line for a coolant for cooling the induction element, wherein the flexible induction element and the coolant line are plastically or elastically deformable multiple times and can manually or automatically be matched to the shape of components to be heated, in such a way that between them and the components to be heated a clearance remains, wherein the flexible induction element and the coolant line are designed so that in a self-supporting manner they maintain this shape during operation of the device.

### TECHNICAL FIELD

A device and a method for the inductive heating of metallic components in particular during welding are provided.

### BACKGROUND

In certain welding processes it is necessary to pre-heat the components to be interconnected, or to maintain them at a certain temperature after the welding process. By pre-heating the components it is possible (depending on the material) to prevent a hardness increase (formation of very hard microstructure zones as a result of certain carbon values being exceeded in the zone affected by heat during welding). In the case of multilayer welding the so-called interpass temperature is important, which should not drop below a certain value in order to prevent the formation of so-called cold cracks. In certain processes, after the actual welding process the components should be kept for a certain period of time at a certain temperature (annealed). In all these cases the components need to be heated with the use of suitable means in addition to the actual welding process.

In a known method that is often used, one or several gas burners are arranged upstream of a welding device, with the components then being made to go past said gas burners in order to preheat the weld seam region of the components to be welded. Depending on the arrangement and alignment of the burners, the material and shape of the components, and the speed at which the components and the burner move relative to each other, heating of the components is very uneven, which can have negative effects on the material of the components. For example, steel 15 NiCuMoNb 5-WB 36 (material number 1.6368), which is very often used in the boiler industry, tolerates only very low rates of heating and cooling and should thus not be preheated by means of a flame.

Apart from so-called flame pre-heating, pre-heating by means of infrared radiation is known, which is intended to prevent the occurrence of temperature peaks in the components. However, as is the case with heating with the use of flames, heating with the use of infrared radiation is very energy-intensive and is associated with energy losses in the region of 70%. Furthermore, by means of infrared radiation, often only superficial heating of the components is possible, while precisely in the case of components of substantial thickness heating of the entire weld seam region is desirable.

For this reason during recent years components have increasingly been heated with the use of induction. In this process, in the weld seam region, upstream of an actual welding device, eddy currents are induced in the components by means of an inductor or induction device, which eddy currents result in resistance heating. Depending on the inductor geometry, weld seam geometry and inductor power, the entire weld seam region can be pre-heated. It is useful to differentiate between two fundamentally different inductor designs, namely rigid and non-rigid inductors, which have each been proven successful in particular applications. Furthermore, it is useful to differentiate between inductors that are actively cooled by way of fluid coolants and that comprise corresponding coolant lines, and inductors that do not comprise coolant lines.

From DE 100 47 492 A1 various rigid inductors are known that do not comprise coolant lines and that are intended for rapid local heating. The inductors have been designed specifically for use with certain weld seam forms (e.g. fillet weld, butt weld), welding processes and components and are used to drastically increase the weld speed in that the components are very quickly inductively heated a short distance (typically approximately 100 mm) before reaching the welding torch. To this effect the inductors are placed so as to be very close above the components. For steels, a working height, in other words a distance between the inductor and the component, of 1 to 2 mm is stated, for aluminum alloys preferably less than 1 mm. Corresponding inductors operate at an inductor power of approximately 15 to 30 kW, with alternating current fields in the frequency range of approximately 9 to 23 kHz being induced. In such arrangements welding speeds of 400 to 1,200 mm/minute are achievable.

Although the special rigid inductors known from the above-mentioned DE 100 47 492 A1 have proven reliable, nevertheless for several reasons they cannot be used in applications, for example in mechanical engineering and construction, where very large and as a rule individually manufactured components, e.g. pipes with diameters in the range of several meters, made of special steels such as high-alloy CrNi steels and fine-grained steels need to be welded together. Thus these components neither tolerate the fast heating described in DE 100 47 492 A1 nor the locally very limited heating desired in this process. Since the inductors are rigid, they are made so as to be component-specific. Since in mechanical engineering and construction custom-made components are regularly used, in each case special inductors would have to be produced, which significantly increases costs. Moreover, in mechanical engineering and construction it is common to hold the large pipes to be welded together so that they are rotatable on their longitudinal axis, and so that they pass a welding device while slowly rotating on their longitudinal axis. The small clearance to be observed according to the teachings described in DE 100 47 492 between the inductor and the components to be heated requires precision during storage and rotation, which in the case of components that are typical in mechanical engineering and construction can, if at all, be met only with disproportionate expense. Since the inductors are not actively cooled and become very hot during operation, they are not suitable for the slow heating of large components, which heating sometimes extends over several hours.

Inductors of the other design type, so-called non-rigid, ribbon-shaped or tubular inductors are, for example, known from US 2007/0215606. They comprise a preferably stranded induction wire or an induction wire strand that is sheathed by a hose through which liquid coolant can be channeled. They are laid out, for example in a spiral pattern, on a component to be heated, or are wrapped in several windings around the component and in practical use have proven to be reliable in particular applications, for example for preheating and for the casting of molds. However, such inductors are not suitable for application in the welding of large rotating components, in particular of pipes in mechanical engineering and construction since, because of their design, they always rest against the components, and with corresponding rotation of the components as a result of friction are taken along, then move into the welding zone or become entangled and rupture. While it would theoretically be possible to use a rigid wire instead of a non-rigid strand, said wire is, however, either unable to transfer the power required for welding large components or, if a wire with a correspondingly large diameter were to be used, so-called skin effects would occur if an alternating current field of the required power were to be applied, which skin effects would drastically increase the resistance of such an inductor, thus impairing its function.

When welding large rotating components, in particular tubes with diameters in the meter range, it is still standard practice to heat the components with open flames or infrared lamps although this is associated with high energy losses, non-uniform heating through, and possibly undesirable temperature peaks.

### BRIEF SUMMARY

It is the object to state a device and a method for the heating of metallic components, which device and method make it possible to economically make use of the advantages provided by inductive heating even in the case of large components that are moving, without this requiring the manufacture of component-specific inductors, and which device and method furthermore make possible slow heating which at times extends over several hours.

The object is met by a device with the characteristics of claim 1 and by a method with the characteristics of claim 12. The secondary independent claim 14 relates to the use of certain plug-in elements to form a device. Advantageous embodiments and implementing forms are part of the dependent claims.

The surprising recognition is that it is possible to create a device suitable for transmitting the induction power required for heating the respective components, which device is hereinafter also referred to as an “inductor”, with a flexible induction element and a flexible coolant line for a coolant for cooling the induction element, in which device the induction element and the coolant line are not only plastically or elastically deformable multiple times and can manually or automatically be matched to the shape of components to be heated in such a way that between said induction element and said coolant line and the components to be heated a clearance remains that makes it possible for the components to move, in particular to rotate, without establishing contact with the inductor, but also in which the induction element and the coolant line are designed in such a manner that in a self-supporting manner they maintain the desired shape during operation of the inductor. In this arrangement the term “self-supporting” denotes that the induction element and the coolant line are able, when they are matched to the shape of a component to be heated, to maintain this shape without additional components such as supports, load-bearing elements, suspensions, etc. at least during operation of the inductor, without being supported by the component. After operation of the inductor the induction element and the coolant line can be matched to the shape of other components, typically to other pipe diameters. In this arrangement various options are available for designing the induction element and the coolant pipe in the described manner, which options are defined in the subordinate claims and are described in detail below.

Further details and advantages will become apparent from the following description, which is purely exemplary and in no way limiting, of three exemplary embodiments in conjunction with the drawing.

### BRIEF DESCRIPTION OF THE DRAWINGS

FIG. 1 shows a section view along the axis of a tubular induction element that at the same time also acts as a coolant line, according to a first exemplary embodiment.

FIG. 2 in a highly schematic manner shows the first exemplary embodiment during use.

FIG. 3 shows a section view along the axis of a coolant line with an attached induction element according to a second exemplary embodiment.

FIG. 4 in a highly schematic manner shows the second exemplary embodiment during use.

FIG. 5 in a schematic manner shows a unit comprising a coolant line and an induction element, which unit is provided in a third exemplary embodiment.

FIG. 6 shows a plug-in element used in the third exemplary embodiment.

### DETAILED DESCRIPTION

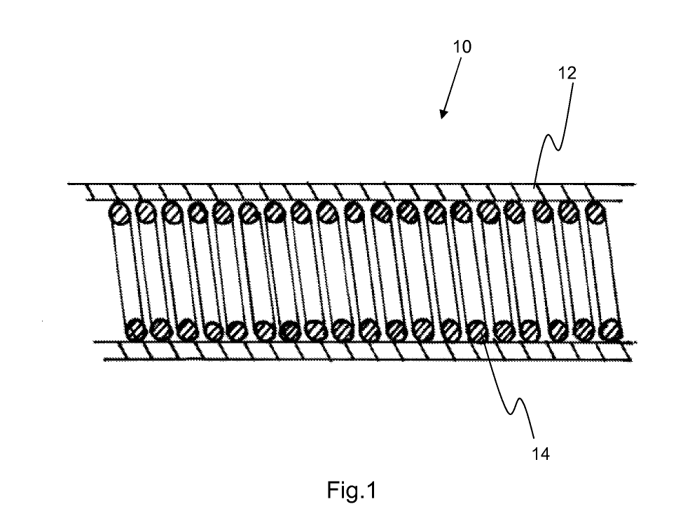

FIG. 1 shows a first embodiment, overall designated by 10, of a device according to the invention for the inductive heating of metallic components, which embodiment comprises an induction element 12 in the form of a pipe, as well as a coil spring 14. The induction element 12 is made from a material such as, for example, aluminum or copper, and is designed with walls that are sufficiently thin that it can be manually bent to a certain extent, and in particular can be matched to different pipe diameters of pipes to be welded, wherein in the interior of the induction element 12 the coil spring 14 is arranged in such a manner that it fits closely against the inner wall of the induction element, thus acting as an anti-kink protection device for the induction element.

The coil spring 14 is made from a non-ferrous metal, preferably of bronze, brass or stainless steel, so that no eddy currents can be induced in it.

The induction element 12 typically comprises a diameter of approximately 5 to 70 mm with a wall thickness of 0.5 to 5 mm and fulfills a double function: it serves both as an induction element and as a coolant line for guiding a liquid coolant that cools the induction element. In other words the induction element and the coolant line are formed integrally in this exemplary embodiment. During operation the induction element is connected to a pump for conveying liquid coolant through the induction element, and to a medium-frequency generator, wherein said medium-frequency generator generates alternating current at a frequency ranging from approximately 1 kHz to 30 kHz, preferably 1 to 16 kHz, and with a power of approximately 1 to 200 kW. The low frequencies have proven to be particularly expedient for slowly heating large components. Typical heating rates range from 100° C. to 400° C. per hour and lower. Certain steels may make it necessary to let the components manufactured therefrom heat or cool at still lower rates, for example 50° C. per hour, which is possible without any problems with the use of the device according to the invention.

The arrangement of the coil spring 14 makes it possible to match the induction element 12 to the shape of the components to be heated, without in this process kinking the induction element 12. At the same time the coil spring makes it possible to design the induction element 12 with relatively thin wall thicknesses and thus in a relatively lightweight construction so that the unit comprising the induction element and the coil spring can maintain the shape adopted even if the coolant flows through the induction element, without in this process the induction element, which is weighed down by the coolant weight, being deformed under the influence of gravity.

The shown embodiment of the invention is suitable for pre-heating prior to welding, for supplementary heating during welding, for the controlled slow cooling and for heat treatment including annealing following the welding of components that are welded in rotating devices. In this context the term “rotating device” refers to devices in which the components during heating are rotated and moved past a stationary inductor, as well as to devices in which the components are stationary while the inductor is moved around the components or in the components.

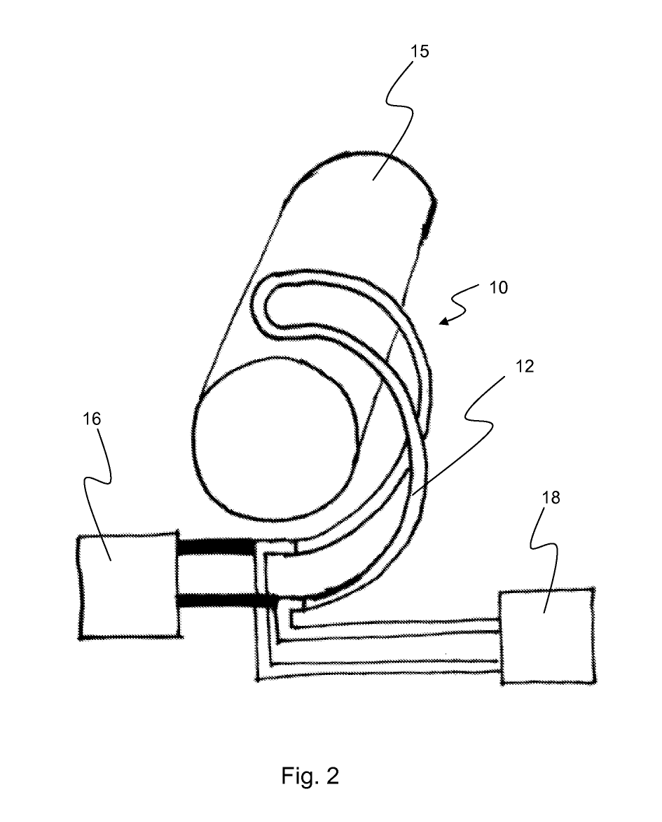

If a device according to FIG. 1 is used, first the induction element, which in this exemplary embodiment only comprises one winding, is thus deflected once by 180°, is matched in such a manner to the shape of the components to be welded that between the components and the pipe 12 a clearance of approximately 10 to 30 mm remains so that the component and the induction element can move relative to each other with some play. FIG. 2 in a highly schematic manner shows the first exemplary embodiment of the invention during use, wherein for the sake of clarity only one component 15 is shown. In the case shown the component 15 is a pipe. Matching the induction element to the shape of the component 15 can take place on the component itself, e.g. with the use of spacers.

With a suitable selection of the wall thickness of the induction element 12 and of the characteristics of the coil spring 14 (number of windings per unit of length, diameter of the spring wire and material of the coil spring), the force required for matching the shape of the induction element can be set.

After matching the induction element to the shape of a component, said induction element is positioned in such a manner that it is located in close proximity to the component to be heated, and so that generating induction currents in the component becomes possible. Depending on the welding speed, welding type, shape of the weld seam, material of the components etc., the optimum frequency range and the power of a medium-frequency generator 16 are set, which medium-frequency generator 16 is electrically connected to the induction element 12. When the medium-frequency generator 16 is switched on, eddy currents are then induced in the component, which eddy currents result in the heating of the component.

In a preferred embodiment of the invention, means for automatically controlling and regulating the power and if applicable the frequency of the medium-frequency generator are provided, wherein these means comprise one or several sensors, in particular for the non-contacting acquisition of the temperature of the components, and a corresponding control unit and regulating unit that depending on the temperature acquired by the temperature sensor or sensors operates the medium-frequency generator in such a manner that in the components the desired temperature gradient results.

The pump 18, which can be connected to a heat exchanger (not shown), ensures that during operation coolant flows through the induction element 12, thus protecting said induction element 12 against overheating.

The device 10 can be arranged in such a manner that it, if applicable together with a welding device, is operated in a stationary manner with the components to be heated, and if applicable to be welded, being guided past it. However, the device 10, if applicable together with a welding device, can also be moved along the components or around the components or in the components. If the components are large pipes to be welded together, the course of action can advantageously be such that the inductor is arranged within the pipes, and a welding device is arranged outside the pipes so that the pipes advantageously serve as a shield against the strong electromagnetic fields generated by the inductor.

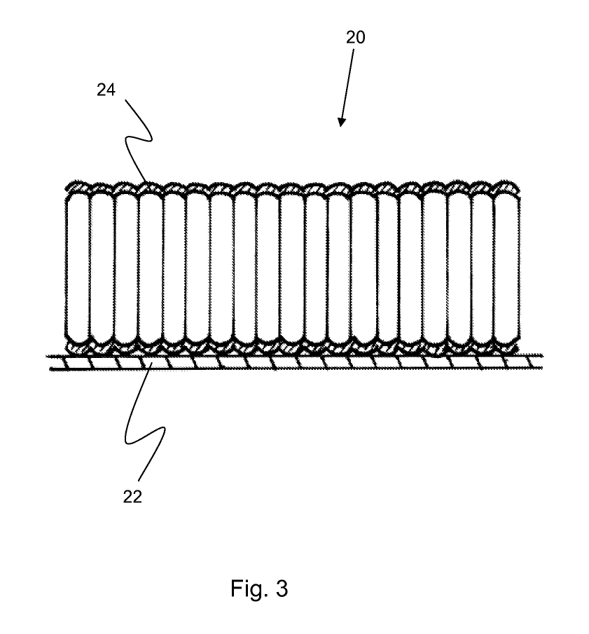

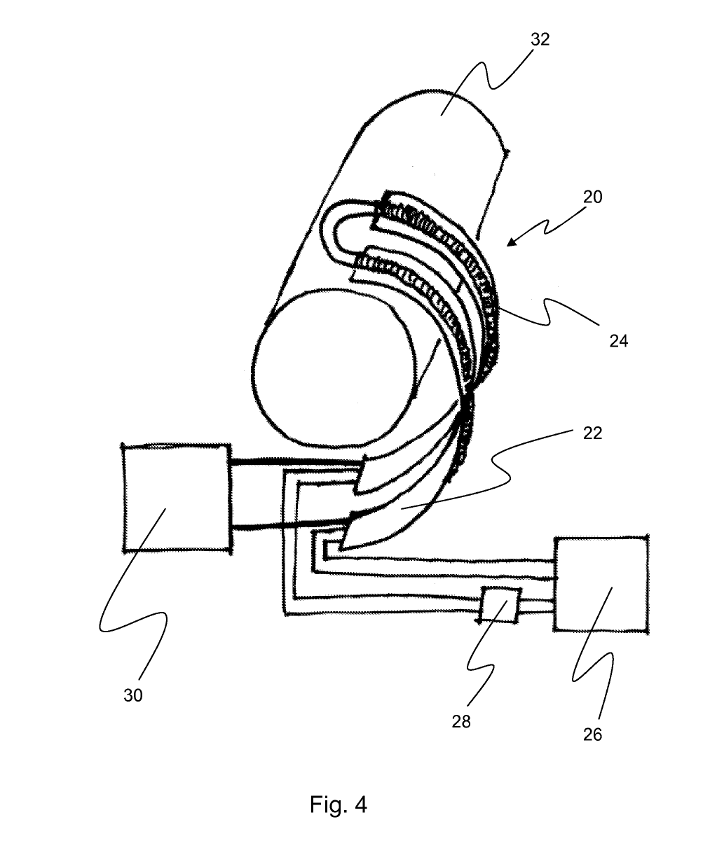

FIGS. 3 and 4 show a second embodiment, overall designated 20, of a device according to the invention for the inductive heating of metallic components, which device in this exemplary embodiment comprises two induction plates 22 and a flexible corrugated pipe 24 with a winding (a deflection by 180°).

The corrugated pipe 24 is preferably manufactured from a non-ferrous metal such as bronze, brass or stainless steel and is attached to the strip-shaped induction plates 22 that are preferably made from copper or aluminum.

The induction plates 22 are used as induction elements, and the corrugated pipe 24 is used as a coolant line for a coolant for cooling the induction elements, wherein during operation of the device a liquid coolant is channeled through the corrugated pipe 24. To this effect the device, during operation a pump 26 is connected for conveying the liquid coolant through the corrugated pipe 24, to a pressure regulator 28 for regulating the pressure present in the interior of the corrugated pipe 24, and to a medium-frequency generator 30.

The corrugated pipe 24 is not only flexible, but can expand depending on the pressure present in its interior. Each of the induction plates 22, which plates 22 in this exemplary embodiment are elongated, is connected to the corrugated pipe 24 on two opposite end regions in such a manner that the corrugated pipe cannot be displaced relative to the respective plate. Between these two regions, depending on the length of the plates, the corrugated pipe can be guided, for example, by means of butt straps soldered to the plates, which butt straps to a certain extent allow displacement of the respective plate relative to the corrugated plate, which butt straps do, however, prevent the corrugated pipe from lifting off the plate. Instead of butt straps it is also possible to use clips or the like.

When the pressure of the coolant in the interior of the corrugated pipe 24 increases, the corrugated pipe expands, thus bending the induction plates 22 as shown in FIG. 4, so that by setting the pressure of the coolant the unit comprising the induction plate and the corrugated pipe can be matched to the shape of the components to be heated.

The corrugated pipe 24 typically comprises a diameter of 5 to 70 mm and a wall thickness of 1 to 7 mm. Each induction plate typically comprises a thickness of 0.5 to 5 mm and measures between 30 and 150 mm in width. The medium-frequency generator 30 typically generates a frequency ranging from approximately 1 to 30 kHz, preferably approximately 1 to 16 kHz, and the inductor power typically ranges from 1 to 200 kW.

As shown in FIG. 4, in the example shown two induction plates 22 are provided that are attached to a shared corrugated pipe 24 and that by means of setting the pressure in the corrugated pipe are made to match the shape of the components 32 to be heated, of which components 32 only one is shown in FIG. 4. In this arrangement the induction plates and the corrugated pipe maintain their shapes in a self-supporting manner during operation as long as the respectively required pressure is present in the interior of the corrugated pipe 24.

Depending on the field of application, instead of the two induction plates shown it is also possible for several plates to be attached to one corrugated pipe, or for individual corrugated pipes, each with an induction plate attached thereto, to be interconnected by way of corresponding connecting pieces in order to form an induction loop.

When using the device 20 the pump 26 is switched on and the pressure of the liquid coolant is set by means of the pressure regulator 28 in such a manner that the induction plates and the coolant line assume the desired curvature. Typically the induction plates are positioned with a clearance of approximately 10 to 30 mm to the surface of the components to be heated in such a manner that the region to be heated is situated in close proximity to the induction plates 22, and eddy currents can be generated in the components. Thereafter, depending on the welding speed, welding type, shape of the weld seam, material of the components etc., the frequency range and the power of the medium-frequency generator are set, wherein advantageously means for automatically controlling and regulating the power and if applicable the frequency of the medium-frequency generator can be provided, which means comprise one or several sensors in particular for the non-contacting acquisition of the temperature of the components, and a corresponding control unit and regulating unit that depending on the temperature/s acquired by the temperature sensor or sensors operates the medium-frequency generator in such a manner that the desired temperature gradient over time results in the components.

As is the case with the device 10, the device 20 can also be designed either for stationary operation, in which the components to be heated are moved past the device, or in order to be moved around the components or along the components or in the components.

The embodiment shown in a highly schematic manner in FIGS. 3 and 4 is particularly suitable for heating components with a round cross section in rotating devices, because the unit comprising the corrugated pipe and the induction plates can particularly easily and quickly be matched to the diameter of the components to be heated.

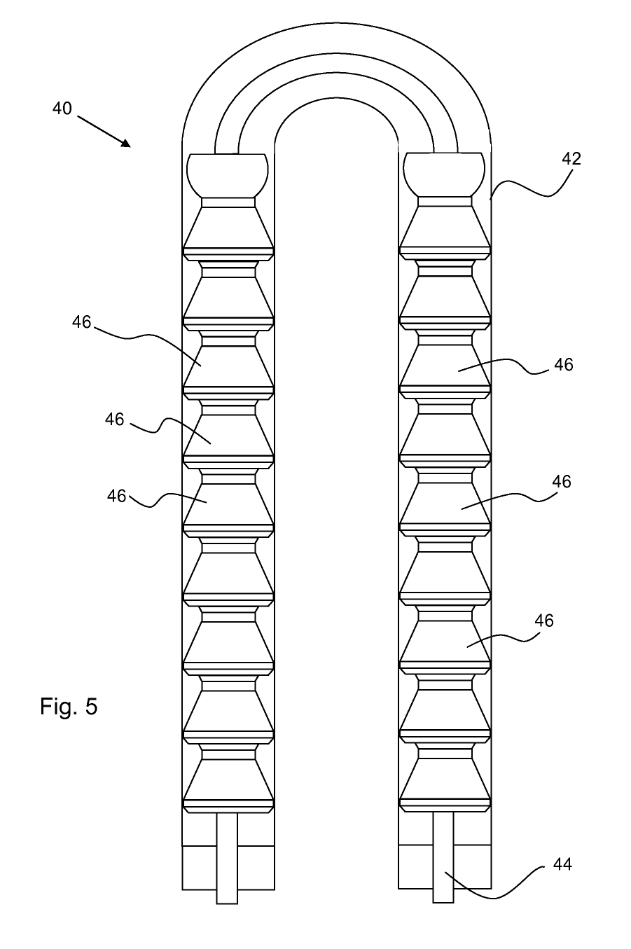

A presently particularly preferred embodiment is shown in a highly schematic manner in FIG. 5. In a device, overall designated 40, for the inductive heating of metallic components in a hose 42, in the diagram shown to be transparent, an induction strand 44 extends, which is also referred to as a high-frequency strand or HF strand, which induction strand 44 in order to prevent skin effects has been elaborately stranded, comprising approximately 500 to 2,000, preferably approximately 1,400 to 1,500 individually lacquer-insulated cores, and which typically in applications under consideration in the present document with induction currents at frequencies of between approximately 1 and 16 kHz and inductor powers of approximately 1 to 200 kW comprises an effective (conductive) cross-sectional area (without the lacquer insulation) of a magnitude of approximately 40 to 50 mm². It is also possible to operate several such strands in parallel.

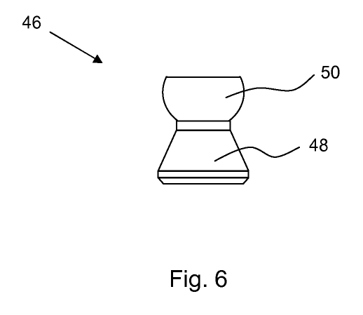

The induction strand is guided through two arms, each comprising a multitude of plug-in elements 46, which in the diagram are shown so as to be non-transparent, wherein the plug-in elements 46, of which for the sake of clarity only a few comprise reference characters, are inserted into the hose 42. FIG. 6 shows an individual plug-in element 46.

As shown in FIG. 6 each of the plug-in elements comprises a receiving portion 48 in the shape of a truncated cone, and a spherical plug-in portion 50, which portions are in each case hollow in the interior so that a liquid or a correspondingly dimensioned HF strand can be guided through the plug-in elements. The inside of the receiving portion 48 is dimensioned and designed and the outside of the spherical plug-in portion 50 is dimensioned and designed in such a manner that the plug-in portion 50 of a plug-in element 46 can be inserted into the receiving portion 48 of a plug-in element 46 of the same type and in that location can be held in a non-positive manner so that the elements in the interior form a line that is liquid-proof per se while the elements can, however, under the influence of force be moved in moderation relative to each other, and the position into which they were moved can then be maintained provided they are not moved to other relative positions by means of force.

By means of these plug-in elements, which as a rule are injection-molded from plastic, it is also possible to form extended deformable arms that then guide the strand so that the unit comprising the arm and the strand forms a flexible induction element that can be multiply-matched to shapes of components to be welded, which induction element can maintain in a self-supporting manner an assumed shape.

The hose 42 shown in FIG. 5 is preferably a silicon hose that comprises a woven Kevlar sheath. Typical dimensions are as follows: hose diameter 20 to 30 mm, preferably approximately 25 mm, wall thickness of the hose 1.5 to 2.5 mm, preferably approximately 2 mm, thickness of the Kevlar sheath 0.1 mm. The Kevlar sheath advantageously assumes various functions. It increases the pressure resistance of the hose, protects said hose against external damage and limits the flexibility of the hose so that it cannot be bent to the extent that the plugged-together plug-in elements 46 can be pulled apart.

In the region of the hose deflection, in other words in the upper region of the diagram shown in FIG. 5, between the two arms formed by the plug-in elements, for example a U-shaped connecting piece can be provided that interconnects the two upper ends of the arms and that improves the stability of the entire unit. Such a connecting piece can be made from a plastic material and can accommodate the HF strand 44. However, it can also be bent from a copper pipe, wherein in that case, however, in order to prevent unnecessary power loss the strand should not be guided through the copper pipe, but instead should be cut and in the region of that end of each arm comprising plug-in elements, which end is situated on the copper pipe, should be soldered to the copper pipe. The reason for this is that otherwise the strand would unnecessarily heat the copper pipe in the region of the copper pipe.

The elements required for operating the device, for example the coolant pump and the medium-frequency generator, which elements have already been described in the context of FIGS. 2 and 4, are not shown in FIG. 5. In this exemplary embodiment the plug-in elements together with the hose form a coolant line that is flexible, and together with the hose are connected to a corresponding pump. In order to facilitate this connection it can advantageously be provided that only those plug-in elements that per se form a liquid-proof line are connected to the pump, and some or all of the plug-in elements comprise holes so that, by way of the plug-in elements, coolant can reach the hose that on both its ends is sealed off, and coolant can leave this hose again.

All the exemplary embodiments shown are particularly suitable for heating large pipes, which for heat treatment and for welding are usually temporarily held so as to be rotatable on their longitudinal axis, which pipes can be inductively heated in a non-contacting manner. The described subject matter advantageously makes it possible for the first time to also economically inductively heat pipes with diameters in the range of several meters, while such pipes for reasons associated with cost hitherto have always been heated with the use of open flames.

The devices, more precisely expressed the induction elements and the coolant lines for cooling the induction elements, can not only be made to approach pipes from the outside, as shown in FIGS. 2 and 4, but from certain pipe diameters onwards can also be arranged in the interior of the pipes. In this arrangement the induction elements are advantageously designed in such a manner that they encompass approximately half to two thirds of the outer circumference of the pipes, or move along approximately half to two thirds of the inner circumference. The latter way of arrangement provides an advantage in that the pipes act as protective shields against the strong induction fields so that personnel can work on the outside on the pipes and can, for example, operate welding devices without having to pay attention to observing particular safety distances to the respective induction elements. In this arrangement the induction elements can thus be deformed so that they extend in an arc-shaped manner over approximately 180° to approximately 270°.

The devices allow the large-area, uniform and controlled heating also of materials that are problematic in terms of heat treatment, for example of high-alloy CrNi steels and fine-grained steels that must only slowly, for example at rates of only approximately 50° C. to 100° C. per hour, be brought to temperatures of typically 100 to 400° C., or that must be cooled only slowly from temperatures used during welding or annealing. Numerous modifications and improvements are possible that relate, for example, to the number and design of the induction elements. For example it is possible to quasi reverse the arrangement of a flexible tube and a coil spring resting against the inner wall of the tube or pipe, which arrangement is shown in the context of FIGS. 1 and 2, and to provide a corresponding coil spring on the outer wall of the pipe, wherein, however, said coil spring needs to be attached to the outer wall of the pipe in order to achieve the desired anti-kink protection, which is not necessary in an internal arrangement. While in all the exemplary embodiments shown only one so-called winding is provided, in order to achieve large-area heating several windings, e.g. 5 or 10, can be provided side by side. If the described plug-in elements are used, it is possible to do without sheathing of the plug-in elements because said plug-in elements themselves form a liquid-proof connection (a so-called plug-in tube). The plug-in elements then form a coolant line for the induction strand guided in them. If in contrast to this a hose sheath of the plug-in elements is provided, the strand need not necessarily be guided through the plug-in elements, but instead can be guided along said plug-in elements. In this arrangement it is also possible to provide several strands in one induction element, in order to transmit greater induction power.

Also implied is a new business process, namely the industrial heating of metallic components, in particular of large pipes with diameters in the meter range by means of induction devices, because such components are as a rule individually manufactured and it is expensive for plant construction firms to contract work such as heating to third parties that thanks to the device can be universally used to carry out various induction heat tasks. This method is expressly designated as forming part of the subject matter described above and is claimed in those countries whose national law permits this.

1. A device for the inductive heating of metallic components in particular during welding, comprising
at least one flexible induction element, and
at least one flexible coolant line for a coolant for cooling the induction element,
Characterized in that
the flexible induction element and the coolant line are plastically or elastically deformable multiple times and can manually or automatically be matched to the shape of components to be heated, in such a way that between said induction element and said coolant line and the components to be heated a clearance remains,
wherein the flexible induction element and the coolant line are designed so that in a self-supporting manner they maintain this shape during operation of the device.

2. The device according to claim 1, characterized in that the induction element and the coolant line are formed integrally, in particular in the form of an electrically conductive pipe through which a liquid coolant can be channeled during operation of the device.

3. The device according to claim 2, wherein the induction element is designed in the form of an electrically conductive pipe, characterized in that in the pipe a coil spring is provided that rests against the inner wall of the pipe.

4. The device according to claim 2, wherein the induction element is designed in the form of an electrically conductive pipe, characterized in that a coil spring is provided that rests against the outer wall of the pipe.

5. The device according to claim 1, characterized in that the flexible induction element is designed as an induction plate, and in that the coolant line is designed as a corrugated pipe attached to the induction plate.

6. The device according to claim 1, characterized in that the flexible induction element comprises a unit of several plug-in elements and a strand guided by means of the plug-in elements.

7. The device according to claim 6, characterized in that the strand is stranded so as to comprise 500 to 2,000, preferably approximately 1,400 to 1,500 individually insulated wires.

8. The device according to claim 1, characterized in that the flexible coolant line comprises several plug-in elements.

9. The device according to claim 6, characterized in that the plug-in elements are guided in a preferably sheathed, in particular Kevlar-sheathed, hose, in particular a silicon hose.

10. The device according to claim 1, characterized in that means for automatically controlling and regulating the power and if applicable the frequency of a medium-frequency generator connected to the induction element are provided, wherein these means comprise one or several sensors, in particular for the non-contacting acquisition of the temperature of the components, and a corresponding control unit and regulating unit that depending on the temperature acquired by the temperature sensor or sensors operates the medium-frequency generator.

11. The device according to claim 1, characterized in that the induction element is dimensioned in such a manner that it can encompass approximately half to two thirds of the outer circumference of a component to be heated, or that it can move along approximately half to two thirds of the inner circumference of a hollow component to be heated.

12. A method for the inductive heating of metallic components, in particular during welding, with the use of a device according to claim 1, characterized by the steps of:
matching of the flexible induction element and of the flexible coolant line to the shape of a component to be heated, in such a manner that between them and the component to be heated a clearance of approximately 10 to 30 mm remains,
generating a relative movement between the induction element and the component to be heated, by rotating the component or the induction element, and applying an alternating voltage to the induction element, preferably an alternating voltage with a frequency of approximately 1 to 30 kHz.

13. The method according to claim 12, characterized in that the component is heated at a heating rate of approximately 50° C. to 100° C.

14. A method for the inductive heating of metallic components, in particular during welding, with the use of a device according to claim 1, characterized by the steps of:
matching of the flexible induction element including a number of plug-in elements, each comprising a receiving portion in the shape of a truncated cone and a spherical plug-in portion, wherein the inside of the receiving portion and the outside of the spherical plug-in portion are dimensioned and designed in such a manner that the plug-in portion of a plug-in element can be inserted into the receiving portion of a plug-in element of the same type and in that location can be held in a non-positive manner and of the flexible coolant line to the shape of a component to be heated, in such a manner that between them and the component to be heated a clearance of approximately 10 to 30 mm remains,
generating a relative movement between the induction element and the component to be heated, by rotating the component or the induction element, and applying an alternating voltage to the induction element, preferably an alternating voltage with a frequency of approximately 1 to 30 kHz.
